(19) United States
(12) Patent Application Publication
(10) Pub. No.: US 2014/0341532 A1
(43) Pub. Date: Nov. 20, 2014

(54) DISTANCE BASED DYNAMIC MODIFICATION OF A VIDEO FRAME PARAMETER IN A DATA PROCESSING DEVICE

(71) Applicant: NVIDAI Corporation, Santa Clara, CA (US)

(72) Inventors: Rahul Ulhas Marathe, Pune (IN); Shounak Santosh Deshpande, Pune (IN)

(73) Assignee: NVIDAI Corporation, Santa Clara, CA (US)

(21) Appl. No.: 13/895,378

(22) Filed: May 16, 2013

(51) Int. Cl. H04N 9/87

(52) U.S. Cl. CPC H04N 9/87
USPC 386/230

(57) ABSTRACT

A method includes receiving, through a processor of a data processing device communicatively coupled to a memory, data related to a distance between the data processing device and a user thereof, the data processing device and an object external to the data processing device and the user and/or the object and the user. The method also includes dynamically modifying, through the processor, a parameter of a video frame being: played back on the data processing device, generated through the data processing device during capturing of a video of the object or captured through the data processing device during the capturing of the video of the object based on the received data related to the distance.

### FIELD OF TECHNOLOGY

This disclosure relates generally to data processing devices and, more particularly, to distance based dynamic modification of a video frame parameter in a data processing device.

### BACKGROUND

A user of a data processing device (e.g., a mobile phone, a tablet) may desire to adjust a parameter (e.g., a brightness level, an audio level) of a video frame being played back thereon depending on an operating environment thereof. The user may be required to manually adjust said parameter through, for example, an interface on the data processing device. The manual mode may be an inconvenience to the user and may offer a limited range of adjustment of the video parameter.

### SUMMARY

Disclosed are a method, a device and/or a system of distance based dynamic modification of a video frame parameter in a data processing device.

In one aspect, a method includes receiving, through a processor of a data processing device communicatively coupled to a memory, data related to a distance between the data processing device and a user thereof, the data processing device and an object external to the data processing device and the user and/or the object and the user. The method also includes dynamically modifying, through the processor, a parameter of a video frame being: played back on the data processing device, generated through the data processing device during capturing of a video of the object or captured through the data processing device during the capturing of the video of the object based on the received data related to the distance.

In another aspect, a data processing device includes a memory, and a processor communicatively coupled to the memory. The processor is configured to execute instructions to: receive data related to a distance between: the data processing device and a user thereof, the data processing device and an object external to the data processing device and the user and/or the object and the user. The processor is further configured to execute instructions to dynamically modify a parameter of a video frame being: played back on the data processing device, generated through the data processing device during capturing of a video of the object or captured through the data processing device during the capturing of the video of the object based on the received data related to the distance.

In yet another aspect, a non-transitory medium, readable through a data processing device and including instructions embodied therein that are executable through the data processing device, is disclosed. The non-transitory medium includes instructions to receive, through a processor of the data processing device communicatively coupled to a memory, data related to a distance between: the data processing device and a user thereof, the data processing device and an object external to the data processing device and the user and/or the object and the user. The non-transitory medium also includes instructions to dynamically modify, through the processor, a parameter of a video frame being: played back on the data processing device, generated through the data processing device during capturing of a video of the object or captured through the data processing device during the capturing of the video of the object based on the received data related to the distance.

The methods and systems disclosed herein may be implemented in any means for achieving various aspects, and may be executed in a form of a machine-readable medium embodying a set of instructions that, when executed by a machine, causes the machine to perform any of the operations disclosed herein.

Other features will be apparent from the accompanying drawings and from the detailed description that follows.

### BRIEF DESCRIPTION OF DRAWINGS

Example embodiments are illustrated by way of example and not limitation in the figures of the accompanying drawings, in which like references indicate similar elements and in which:

FIG. 1 is a schematic view of a data processing device, according to one or more embodiments.

FIG. 2 is a schematic view of distance data from a proximity sensor being utilized along with input from a light sensor interfaced with a processor of the data processing device of FIG. 1 to effect a dynamic modification of a brightness level of a video frame.

FIG. 3 is schematic view of an example scenario of two proximity sensors and a video camera being utilized to vary parameters associated with video data being rendered on a display unit of the data processing device of FIG. 1 and/or video data being generated through the data processing device of FIG. 1.

FIG. 4 is a schematic view of interaction between a driver component and the processor of the data processing device of FIG. 1, the display unit of the data processing device of FIG. 1 and/or the proximity sensor associated therewith, according to one or more embodiments.

FIG. 5 is a schematic view of an example proximity sensor.

FIG. 6 is a process flow diagram detailing the operations involved in distance based dynamic modification of a video frame parameter in the data processing device of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of distance based dynamic modification of a video frame parameter in a data processing device. Although the present embodiments have been described with reference to specific example embodiments, it will be evident that various modifications and changes may be made to these embodiments without departing from the broader spirit and scope of the various embodiments.

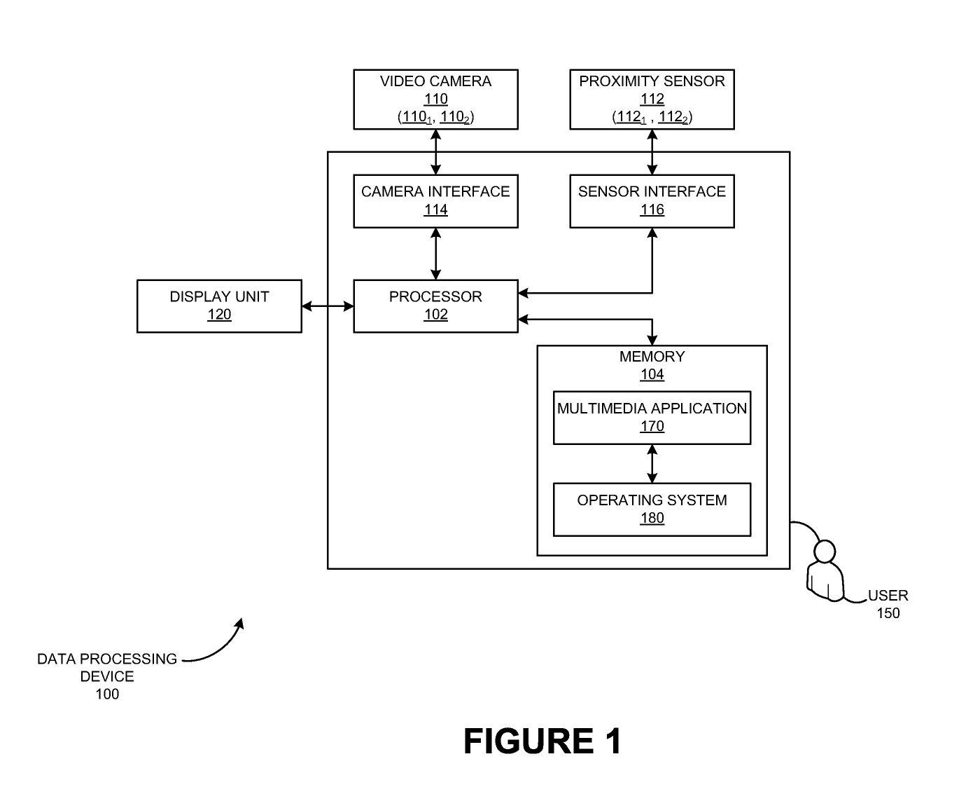

FIG. 1 shows a data processing device 100, according to one or more embodiments. In one or more embodiments, data processing device 100 may be a desktop computer, a laptop computer, a notebook computer, a tablet, a netbook, or a mobile device such as a mobile phone or a portable smart video camera. Other forms of data processing device 100 are within the scope of the exemplary embodiments discussed herein. In one or more embodiments, data processing device 100 may include a processor 102 (e.g., a Central Processing Unit (CPU), a Graphics Processing Unit (GPU)) communicatively coupled to a memory 104 (e.g., a volatile memory and/or a non-volatile memory); memory 104 may include storage locations configured to be addressable through processor 102.

In one or more embodiments, data processing device 100 may include a video camera 110 associated therewith to extend the capabilities thereof, as will be discussed below. FIG. 1 shows video camera 110 (e.g., including an image sensor) as being interfaced with processor 102 through a camera interface 114. Camera interface 114 may be configured to convert an output of processor 102 to a format compatible with video camera 110. In one or more embodiments, in order to extend the capabilities of video camera 110, data processing device 100 may include a proximity sensor 112 associated therewith to enable varying parameters associated with a video playback therethrough (e.g., through processor 102) based on a distance between a user 150 thereof and data processing device 100. In one or more embodiments, said variation of parameters may also be effected based on a distance between user 150 and a target object being captured (as will be seen below) and/or a distance between data processing device 100 and the target object. In the latter case, two video cameras (e.g., video camera 110₁ and video camera 110₂) and/or at least two proximity sensors (e.g., proximity sensor 112₁, proximity sensor 112₂) may be required. In one or more embodiments, data processing device 100 may include a display unit 120 (e.g., interfaced with processor 102) associated therewith to have an output of processor 102 rendered thereon.

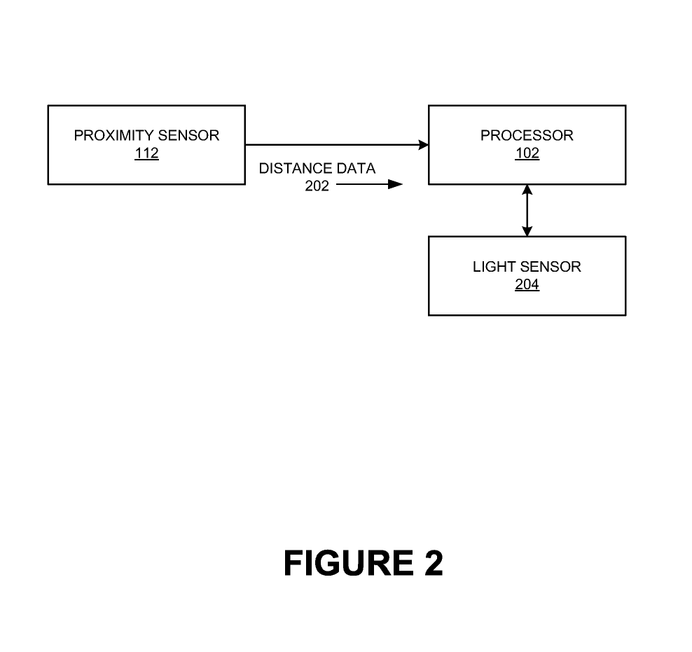

It should be noted that the number of proximity sensors and video cameras are not limited to one or two. Further, it should be noted that a proximity sensor may include a number of sensors configured to provide one or more functionalities associated therewith. In one or more embodiments, proximity sensor 112 may be interfaced with processor 102 through a sensor interface 116. In an example scenario, user 150 may be viewing a bright image/sequence of video frames on display unit 120. Here, proximity sensor 112 may calculate the distance between user 150 and data processing device 100, which then is utilized as a bias for contrast adjustment during a post-processing operation performed as part of video playback. FIG. 2 shows distance data 202 from proximity sensor 112 being utilized along with input from a light sensor 204 interfaced with processor 102 (e.g., through sensor interface 116, another sensor interface). Here, processor 102 may execute instructions to compute the requisite distance based on distance data 202 received from proximity sensor 112. Further, processor 102 may be configured to receive data from light sensor 204 to determine an optimal brightness value to which a current brightness of a video frame being rendered on display unit 120 is modified to.

For example, determination of the optimal brightness value may involve utilizing histogram data collected from the decoded (e.g., through processor 102) version of the video frame collected “on screen” (e.g., data rendered on display unit 120). The histogram data may represent tonal distribution in the video frame.

Artifacts in the video frame may be less noticeable when viewed from a greater distance. Thus, in another example scenario, complexity of scaling/edge enhancement/noise reduction/image-video frame sharpening algorithms may be dynamically modulated based on the calculated distance. The aforementioned algorithms may be implemented as a module/module(s) configured to execute through processor 102. Executing algorithms of reduced complexity may reduce power consumption; this may add balance to the power consumption that occurs during the contrast adjustment. Said modification of the complexity of the algorithms may be regarded as modification of one or more parameter(s) associated with the video frame.

Furthermore, it is obvious that volume level associated with the video frame should increase with increasing distance between data processing device 100/display unit 120 and user 150. Thus, in yet another example scenario, the calculated distance may be utilized through processor 102 to dynamically modify volume levels associated with the video data being rendered on display unit 120. It should be noted that the aforementioned scenarios of dynamically varying parameters associated with the video data rendered on display unit 120 are merely discussed for illustrative purposes. Varying other parameters is within the scope of the exemplary embodiments discussed herein.

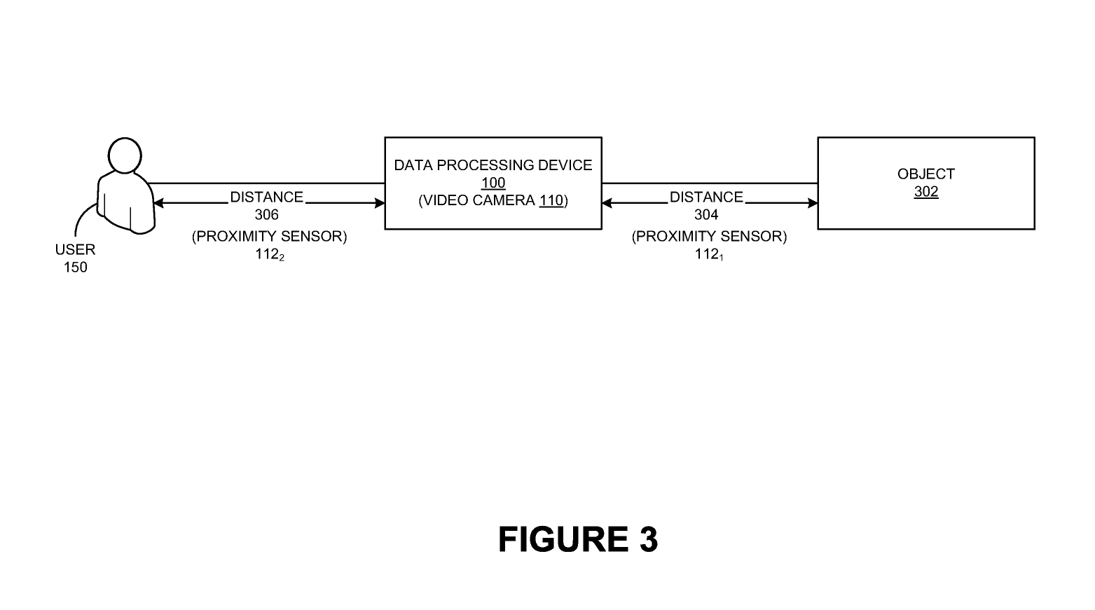

FIG. 3 shows an example scenario of two proximity sensors (112₁, 112₂) and video camera 110 being utilized to vary parameters associated with video data being rendered on display unit 120 and/or video data being generated through data processing device 100. For example, data processing device 100 may be utilized during shooting wildlife or a nature scene. Here, an object 302 to be captured may be an animal such as a tiger. While user 150 is shooting object 302, the distance (e.g., distance 304) between data processing device 100 and object 302 may be sensed through proximity sensor 112₁. In the case of data processing device 100 being stationed away from user 150, proximity sensor 112₂ may be configured to sense the distance (e.g., distance 306) between user 150 and data processing device 100. Distance 304 and distance 306 may be summed up through processor 102 to dynamically adapt parameters of the video frame being rendered on display unit 120 in accordance with the distance between user 150 and object 302. For example, user 150 may wish to shoot a video from a perspective of being at a current location thereof. However, circumstances may dictate placement of data processing device 100 at a location different from the current location. Here, data processing device 100 may provide for the desired perspective even though the location thereof is different from that of user 150 through processor 102 executing instructions to estimate the distance between user 150 and object 302.

It should be noted that all scenarios and/or variations thereof involving estimation of distance between user 150 and object 302, user 150 and data processing device 100 and data processing device 100 and object 302 are within the scope of the exemplary embodiments discussed herein. Further, it should be noted that exemplary embodiments are also applicable to cases involving dynamic modification of video parameters during recording and capturing thereof, in addition to the playback discussed above. All reasonable variations are within the scope of the exemplary embodiments discussed herein.

In one or more embodiments, proximity sensor 112 may be calibrated to sense/report distance in incremental steps (e.g., in steps of 10 cm, 5 cm). In one or more embodiments, each incremental step may be associated with a predefined set of video parameters. Alternately, in one or more embodiments, each incremental step may be associated with an intelligently determined video parameter or a set of video parameters through processor 102.

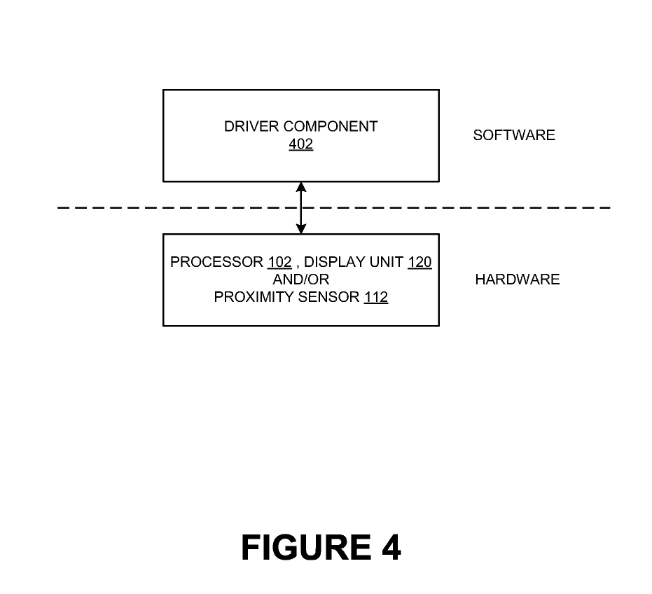

FIG. 4 shows interaction between a driver component 402 (e.g., a set of instructions) and processor 102, display unit 120 and/or proximity sensor 112, according to one or more embodiments. In one or more embodiments, driver component 402 may be configured to initiate the capturing of the distance data through proximity sensor 112 and/or the dynamic modification of the video parameters through processor 102 based on the sensed distance data. In one or more embodiments, said driver component 402 may be packaged with a multimedia application 170 executing on data processing device 100 and/or an operating system 180 executing on data processing device 100. FIG. 1 shows multimedia application 170 and operating system 180 as part of memory 104 of data processing device 100. Further, in one or more embodiments, instructions associated with driver component 402, the sensing of the distance and/or the dynamic modification of the video parameters may be tangibly embodied on a non-transitory medium (e.g., a Compact Disc (CD), a Digital Video Disc (DVD), a Blu-ray disc®, a hard drive; appropriate instructions may be downloaded to the hard drive) readable through data processing device 100.

It should be noted that the distance sensing and the dynamic modification of the video parameters may be automatically initiated during video playback, video capturing or video recording. Also, the aforementioned processes may execute in the foreground or background. Further, the processes may be initiated by user 150 through a user interface (not shown) associated with multimedia application 170 and/or a physical button associated with data processing device 100. All reasonable variations are within the scope of the exemplary embodiments discussed herein.

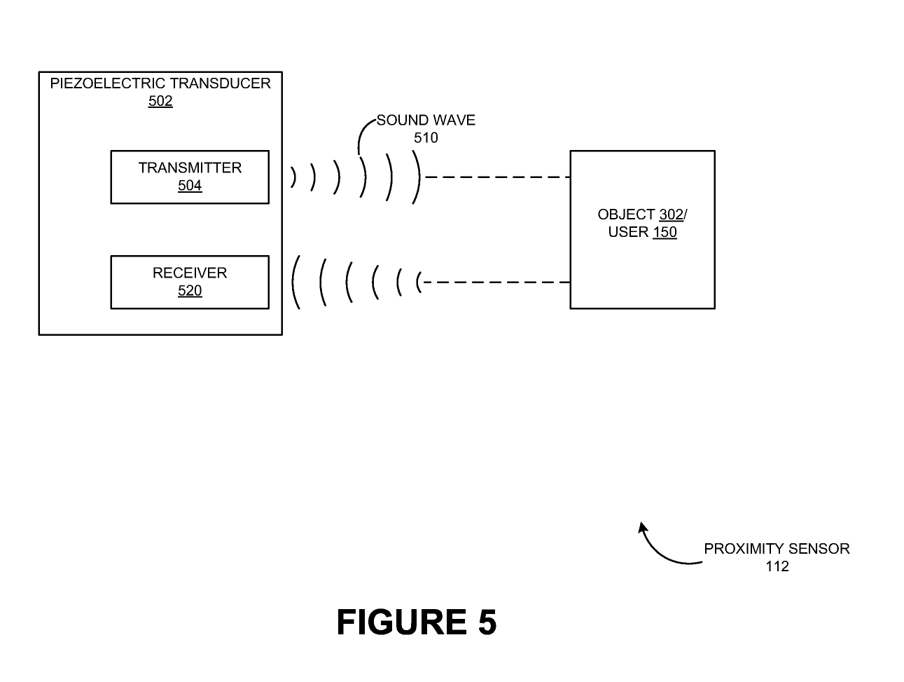

FIG. 5 shows an example proximity sensor 112. Here, proximity sensor 112 may employ a piezoelectric transducer 502 to transmit and detect sound waves. A sound wave 510 of a high frequency may be generated through a transmitter 504 portion of piezoelectric transducer 502. Sound wave 510 may bounce off object 302 and/or user 150 as applicable, and the echo may be received at a receiver 520 portion of piezoelectric transducer 502. Proximity sensor 112 may transmit the time interval between signal transmission and reception to processor 102, which calculates the appropriate distance required based on the time interval.

In another example embodiment, proximity sensor 112 may include an antenna (not shown) configured to have known radiation transmission characteristics thereof. When the antenna transmits electromagnetic radiation to object 302 and/or user 150, the known radiation characteristics may be modified. The modified radiation characteristics may, in turn, be utilized to characterize the distance between data processing device 100 and user 150, data processing device 100 and object 302 and/or object 302 and user 150. It is to be noted that other forms of proximity sensor 112 and/or mechanisms of proximity sensing are within the scope of the exemplary embodiments discussed herein. Further, it is to be noted that data from proximity sensor 112 may be combined with data from one or more other sensors (e.g., light sensor 204) to dynamically modify the video parameters discussed above.

Last but not the least, a processor (not shown) associated with proximity sensor 112 may be utilized for the distance estimation and/or the dynamic modification of the video parameters instead of processor 102. Said processor may, again, be communicatively coupled to a memory (not shown). In an example scenario, data processing device 100 may merely receive (e.g., through processor 102) the distance data based on which processor 102 effects the dynamic modification of the video parameters discussed above. Alternately, user 150 may input the aforementioned distance data.

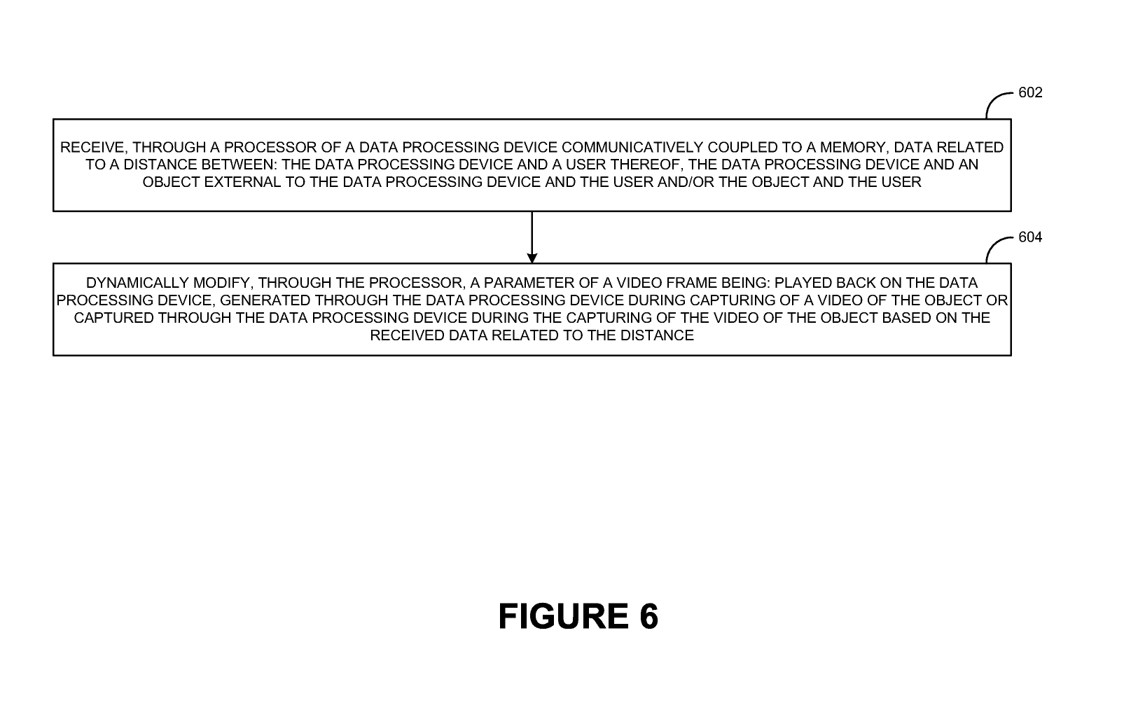

FIG. 6 shows a process flow diagram detailing the operations involved in distance based dynamic modification of a video frame parameter in data processing device 100, according to one or more embodiments. In one or more embodiments, operation 602 may involve receiving, through processor 102, data related to a distance between data processing device 100 and user 150, data processing device 100 and object 302 and/or object 302 and user 150. In one or more embodiments, operation 604 may then involve dynamically modifying, through processor 102, a parameter of a video frame being: played back on data processing device 100, generated through data processing device 100 during capturing of a video of object 302 or captured through data processing device 100 during the capturing of the video of object 302 based on the received data related to the distance.

Although the present embodiments have been described with reference to a specific example embodiment, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine-accessible medium compatible with a data processing system (e.g., data processing device 100). Accordingly, the specification and drawings are to be regarded in an illustrative in rather than a restrictive sense.

What is claimed is:

1. A method comprising:
receiving, through a processor of a data processing device communicatively coupled to a memory, data related to a distance between at least one of: the data processing device and a user thereof, the data processing device and an object external to the data processing device and the user, and the object and the user; and
dynamically modifying, through the processor, a parameter of a video frame being one of: played back on the data processing device, generated through the data processing device during capturing of a video of the object and captured through the data processing device during the capturing of the video of the object based on the received data related to the distance.

2. The method of claim 1, further comprising sensing the data related to the distance through a proximity sensor associated with the data processing device in conjunction with at least one of: the processor of the data processing device and another processor associated with the proximity sensor.

3. The method of claim 2, further comprising utilizing data from another sensor in conjunction with the data related to the distance from the proximity sensor to effect the dynamic modification of the parameter of the video frame.

4. The method of claim 2, comprising initiating at least one of: the sensing of the data related to the distance and the dynamic modification of the parameter of the video frame through a driver component associated with at least one of: the processor of the data processing device, the proximity sensor and a display unit associated with rendering video data from the data processing device.

5. The method of claim 1, wherein the dynamic modification of the parameter of the video frame includes determining, through the processor of the data processing device, an optimal value of the parameter of the video frame.

6. The method of claim 2, further comprising calibrating the proximity sensor to enable the dynamic modification of the parameter of the video frame in accordance with an incremental variation of the sensed data related to the distance.

7. The method of claim 2, comprising providing at least one of: a sound wave detection based sensor and an electromagnetic radiation characteristic detection based sensor as the proximity sensor.

8. A data processing device comprising:
a memory; and
a processor communicatively coupled to the memory, the processor being configured to execute instructions to:
receive data related to a distance between at least one of: the data processing device and a user thereof, the data processing device and an object external to the data processing device and the user, and the object and the user, and
dynamically modify a parameter of a video frame being one of: played back on the data processing device, generated through the data processing device during capturing of a video of the object and captured through the data processing device during the capturing of the video of the object based on the received data related to the distance.

9. The data processing device of claim 8, further comprising a proximity sensor associated with the data processing device to sense the data related to the distance in conjunction with at least one of: the processor of the data processing device and another processor associated with the proximity sensor.

10. The data processing device of claim 9, wherein the processor is further configured to utilize data from another sensor in conjunction with the data related to the distance from the proximity sensor to effect the dynamic modification of the parameter of the video frame.

11. The data processing device of claim 9, further comprising a driver component associated with at least one of: the processor of the data processing device, the proximity sensor and a display unit associated with rendering video data from the data processing device to initiate at least one of: the sensing of the data related to the distance and the dynamic modification of the parameter of the video frame.

12. The data processing device of claim 9, wherein the proximity sensor is calibrated to enable the dynamic modification of the parameter of the video frame in accordance with an incremental variation of the sensed data related to the distance.

13. The data processing device of claim 9, wherein the proximity sensor is at least one of: a sound wave detection based sensor and an electromagnetic radiation characteristic detection based sensor.

14. A non-transitory medium, readable through a data processing device and including instructions embodied therein that are executable through the data processing device, comprising:
instructions to receive, through a processor of the data processing device communicatively coupled to a memory, data related to a distance between at least one of: the data processing device and a user thereof, the data processing device and an object external to the data processing device and the user, and the object and the user; and
instructions to dynamically modify, through the processor, a parameter of a video frame being one of: played back on the data processing device, generated through the data processing device during capturing of a video of the object and captured through the data processing device during the capturing of the video of the object based on the received data related to the distance.

15. The non-transitory medium of claim 14, further comprising instructions to sense the data related to the distance through a proximity sensor associated with the data processing device in conjunction with at least one of: the processor of the data processing device and another processor associated with the proximity sensor.

16. The non-transitory medium of claim 15, further comprising instructions to utilize data from another sensor in conjunction with the data related to the distance from the proximity sensor to effect the dynamic modification of the parameter of the video frame.

17. The non-transitory medium of claim 15, comprising instructions to initiate at least one of: the sensing of the data related to the distance and the dynamic modification of the parameter of the video frame through a driver component associated with at least one of: the processor of the data processing device, the proximity sensor and a display unit associated with rendering video data from the data processing device.

18. The non-transitory medium of claim 14, wherein the instructions to dynamically modify the parameter of the video frame includes instructions to determine, through the processor of the data processing device, an optimal value of the parameter of the video frame.

19. The non-transitory medium of claim 15, further comprising instructions to calibrate the proximity sensor to enable the dynamic modification of the parameter of the video frame in accordance with an incremental variation of the sensed data related to the distance.

20. The non-transitory medium of claim 15, comprising instructions compatible with the proximity sensor being at least one of: a sound wave detection based sensor and an electromagnetic radiation characteristic detection based sensor.
